(19) United States
(12) Patent Application Publication
(10) Pub. No.: US 2020/0203729 A1
(43) Pub. Date: Jun. 25, 2020

(54) Nano-Alginate Battery

(71) Applicant: Amen Dhyllon, Wynnewood, PA (US)

(72) Inventor: Amen Dhyllon, Wynnewood, PA (US)

(21) Appl. No.: 16/794,661

(22) Filed: Feb. 19, 2020

Related U.S. Application Data
(63) Continuation-in-part of application No. 16/226,689, filed on Dec. 20, 2018, now abandoned.

(51) Int. Cl. H01M 4/583; H01M 4/505; H01M 4/525; H01M 4/38; H01M 10/0562; H01M 10/0563; H01M 2/16

(52) U.S. Cl. CPC H01M 4/583; H01M 4/505; H01M 4/525; H01M 4/386; H01M 2300/0074; H01M 10/0562; H01M 10/0563; H01M 2/1653; H01M 4/382

(57) ABSTRACT

A high-capacity, thermally stable battery comprising nanostructures of carbon or gold, suspended in an algal-derived matrix.

### RELATIONSHIP TO OTHER APPLICATIONS

This is a continuation-in-part of U.S. application Ser. No. 16/226,689 filed 20 Dec. 2018, which is incorporated by reference.

### FIELD OF THE INVENTION

The invention relates to batteries with high thermal stability comprising nanostructures and alginate components.

### BACKGROUND OF THE INVENTION

The main components of a battery are the cathode and anode, separated from one another by a separator, which is saturated with a liquid electrolyte that allows the movement of ions from cathode to anode when charging, and facilitates the reverse on discharge. Despite that fact that ions pass freely between the electrodes, the separator has no electrical conductivity, does not in any case conduct electrons, and acts as an isolator.

A traditional dry cell battery usually has a zinc anode, usually in the form of a cylindrical pot, with a central carbon cathode rod in the middle. The electrolyte is traditionally an ammonium chloride paste within an in contact with the zinc anode. Between the electrolyte and carbon cathode is a second paste consisting of ammonium chloride and manganese dioxide, the latter acting as a depolarizer. In some designs, the manganese dioxide is replaced by zinc chloride.

Rechargeable batteries store energy through a reversible electrochemical reaction. Many different combinations of electrode materials and electrolytes are used, including lead-acid, nickel-cadmium (NiCd), nickel-metal hydride (NiMH), lithium-ion (Li-ion), and lithium-ion polymer (Li-ion polymer). Li-ion batteries are the most popular and useful of the modern rechargeable batteries. In Li-ion batteries, lithium ions move from the negative electrode through an electrolyte to the positive electrode during discharge, and back when charging. Li-ion batteries use an intercalated lithium compound as the material at the positive electrode and typically graphite at the negative electrode. The batteries have a high energy density, no memory effect (other than LFP cells) and low self-discharge. They can however be a safety hazard since they contain a flammable electrolyte, and if damaged or incorrectly charged can lead to explosions and fires.

A major problem with rechargeable batteries is that they can experience thermal runaway resulting in overheating, explosion and fire. Samsung were forced to recall Galaxy Note 7 handsets following lithium-ion fires, and there have been several incidents involving batteries on Boeing 787s. For most lithium-ion cells, the lithium-oxide electrode is the positive electrode; for titanate lithium-ion cells (LTO), the lithium-oxide electrode is the negative electrode. The risk of fire and explosion from Lithium-ion batteries is well documented and is believed to be associated with use of liquid electrolytes. Thermal runaway occurs when the current through a battery creates sufficient heat for its temperature to rise above a critical value, resulting in ultimate destruction of the device. Particularly prone to thermal runaway are lithium-ion batteries, particularly lithium polymer batteries. In 2006, batteries from Apple, HP, Toshiba, Lenovo, Dell and other notebook manufacturers were recalled because of fire and explosions. The Pipeline and Hazardous Materials Safety Administration (PHMSA) of the U.S. Department of Transportation has established regulations regarding the carrying of certain types of batteries on airplanes because of their instability in certain situations.

Carbon materials have been used in batteries for many years, for example a zinc-carbon battery is a dry cell primary battery that delivers about 1.5 volts of direct current from the electrochemical reaction between zinc and manganese dioxide. A carbon rod collects the current from the manganese dioxide electrode.

Carbon nano-materials have been used in battery components and exhibit exceptional electrical, thermal, chemical and mechanical properties. In this disclosure, carbon nanomaterials are used to produce a high-powered battery which is thermally stable, and does not exhibit thermal runaway properties.

In this disclosure, nanomaterials, lithium compounds and silicon may be employed in the anode. Lithium-silicon batteries are lithium-ion batteries that employ a silicon anode and lithium ions as the charge carriers. Silicon has a much larger energy storage capacity compared to graphite. The amounts of silicone in the anode may be up to about 10%. A crystalline silicon anode has a theoretical specific capacity of 3600 mAh/g, approximately ten times that of anodes such as graphite (372 mAh/g). Each silicon atom can bind up to 3.75 lithium atoms in its fully lithiated state (Li 3.75Si), compared to one lithium atom per 6 carbon atoms for the fully lithiated graphite (LiC6). Silicon microparticles may be mixed with carbon or gold nanospheres or nanotubes, or encapsulated in a graphene, carbon or gold nano-shell.

Composite silicon-Li-ion anodes made from nanometer-size silicon powder has a high reversible capacity of 2400 mAh g⁻¹ and an improved cycling stability compared to micrometer-sized powder. But silicon-Li-ion are still susceptible to thermal runaway, especially batteries with a liquid electrolyte. There is clearly a long-felt need for a high-capacity battery that is thermally stable and does not experience thermal runaway.

Alginate is a biomaterial that has found numerous applications in biomedical science and engineering. Alginate is generally defined as a salt of alginic acid, a colloidal substance from brown seaweed; used, in the form of calcium, sodium, or ammonium alginate, for dental impression materials. It is cheaply extracted from common, fast-growing brown algae.

### BRIEF DESCRIPTION OF THE INVENTION

The invention encompasses a high-capacity, thermally stable battery comprising nanostructures of carbon or gold, suspended in an algal-derived matrix. The inventor has discovered that using alginate materials in battery components provides enhanced electrical and thermal stability and reduces swelling and volume increase and dampens and moderates thermal runaway. The use of nanomaterial such as carbon or gold nanotubes of nanospheres increases energy capacity, cycle life, and reduced hysteresis loss. Algal-derived material (e.g., alginate) is used in the invention as a binder material to suspend silicon or graphite or nanoparticles which interact with the electrolyte to facilitate flow of current.

The invention encompasses a number of embodiments of a battery having specific components. In a representative general embodiment, the anode comprises nanostructures of either carbon, graphene or a metal such as gold, as well as one or more silicon compounds, mixed with algae-derived material such as an alginate material. The cathode comprises a lithium compound and carbon nanostructures (optionally mixed with an alginate); the electrolyte is a solid electrolyte (optionally liquid), and the separator comprises an alginate.

In certain more specific embodiments the anode is a silicon-lithium-ion anode mixed with carbon or gold nanostructures, and an alginate compound. In other embodiments the anode and cathode both comprise lithium compounds such as lithium oxides or lithium iron phosphates. In other specific embodiments the anode and cathode comprise gold or carbon nanospheres or nanotubes. In embodiments employing a silicon-Li-ion anode, the silicon microparticles may be encapsulated in a graphene or gold nanosphere shell. The cathode additionally may comprise a material made from algae, such as alginates, which the inventor has discovered, provides enhanced electrical and thermal stability and reduces swelling and volume increase and dampens and moderates thermal runaway.

A preferred embodiment is a battery wherein the anode comprises carbon nanostructures an alginate material; and wherein the cathode comprises lithium oxide and carbon nanostructures; and wherein the electrolyte is a solid electrolyte, and wherein the separator comprises an alginate material.

### BRIEF DESCRIPTION OF THE DRAWINGS

FIG. 1 is a schematic generalized diagram of the battery of the invention, displaying:

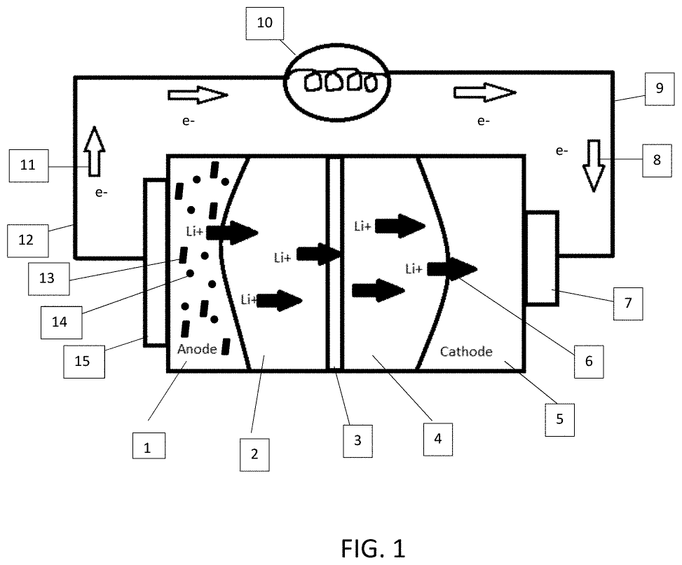

(1) anode

(2) electrolyte

(3) separator

(4) electrolyte

(5) cathode

(6) lithium ion direction of travel

(7) cathode current collector terminal

(8) electron direction of travel

(9) conductor part of circuit

(10) resistor e.g., bulb

(11) electron direction of travel

(12) conductor part of circuit

(13) alginate particle

(14) nanospheres or nanotube structure

(15) anode current collector terminal

### DETAILED DESCRIPTION

The Nano-Alginate Battery (NAB) of the invention is a high power battery that is thermally stable and does not exhibit thermal runaway and provides long operational life. A specific aspect of the present invention is that the battery includes an anode comprised of nanocarbon structures and an alginate, and that the separator also includes alginates.

The Nano-Alginate Battery of the invention uses nanostructures such as carbon or gold nanospheres or nanotubes and algal-derived materials (e.g., alginate) to improve efficiency, increase charge capacity.

In the Nano-Alginate Battery of the invention, algal-derived material (e.g., alginate) is used as a binder material to suspend silicon or graphite or nanoparticles (e.g., gold of carbon nanotubes of nanospheres) particles which interact with the electrolyte to provide a flow of current, and hence, power. It is cheaply extracted from common, fast-growing brown algae. Use of alginate and other compounds derived from algae can increase energy storage and output for both graphite-based electrodes and silicon-based electrodes. The present disclosure uses alginate as a battery component to decrease, dampen, dissipate and moderate heat generation, thereby decreasing thermal runaway.

The battery of the invention typically uses Lithium cobalt oxide (LiCoO₂) in the positive electrode, and carbon in the negative electrode. A single battery of the invention may range in size and energy capacity from 3 Wh to thousands of Wh. A typical AA-sized Li-ion battery of the invention may provide between 3 Wh and 15 Wh or energy, similar to the range for Tesla battery packs using Panasonic 18650 batteries.

The Anode

The anode (or negative electrode) is the electrode in the cell from which electrons flow, which is opposite to the direction of “conventional current” (the flow of positive charges). Thus negatively charged electrons flow out the anode into the external circuit, and conventional current (positive charge) is said to flow from the cathode to the anode.

Graphite is conventionally used as the main anode material, which may be mixed with other substances as described herein. The anode material may preferably blend graphite and silicon, which increases the amount of lithium that can be reversibly held and released by the anode upon charge and discharge respectively. The blending of silicon with graphite increases the maximum amount of lithium that can be intercalated within the blended anode structure. Li-ion cells can be constructed as cylindrical, flat or prismatic cells with thin-walled cases or in any other cell configurations.

The invention encompasses a Nano-Alginate Battery (NAB) using nanostructures within the anode. The nanostructures may be of any conducting material. In a preferred embodiment the anode comprises nanotubes or nanoparticles, made from Carbon, Gold or other materials.

The anode of the invention incorporates materials including or mixed with alginates or other natural fibers such as lignin, wood-derived material, algal-derived material etc. The algal-derived material (e.g., alginate) functions as a binder in which silicon or graphite or nanoparticles (e.g., gold of carbon nanotubes of nanospheres) are suspended, which interact with the electrolyte to provide a flow of current. Use of alginate and other compounds derived from algae can dampen, dissipate and moderate heat generation, thereby decreasing thermal runaway.

In a preferred embodiment the anode also includes a high energy-density material such as silicon in contact with or blended with the carbon nanostructures.

In an optional preferred embodiment the anode also is doped with boron (B) or a related element such as aluminum (Al), gallium (Ga), indium (In), thallium (Tl), and nihonium (Nh).

Another embodiment utilizes a silicon/carbon composite anode that may further include nanostructures such as nanotubes or nanoparticles, made from Carbon, Gold or other materials.

An interesting embodiment utilizes gold nanospheres in the anode, and particularly nanospheres with a hollow core and very rugose surface morphology, and therefore large surface area, increasing their energy-dens and charge capacity. Such particles may be made, for example, by the methods outlined in US20160153977A1, filed Feb. 8, 2016 and in related applications Ser. No. 13/199,563, filed Sep. 3, 2011, and Ser. No. 11/396,098, entitled “Novel Gold Nanoparticle Aggregates and Their Applications”, filed Mar. 30, 2006, all of which are incorporated fully by reference.

In a related embodiment, hollow carbon nanospheres can be used. These may be synthesized, for example, via the hydrothermal carbonization of glucose in the presence of nano-sized latex templates. The resulting disordered carbon hollow nanospheres exhibits excellent characteristics in terms of reversible capacities, cycling performance, and rate capability for application as an anode material in Na-based batteries. See tang et al., “Hollow Carbon Nanospheres with Superior Rate Capability for Sodium-Based Batteries” Volume2, Issue? Special Issue: Battery Materials July, 2012 Pages 873-877.

Silicon-Carbon nanoparticles may also be used. Synthesis of Si—C nanoparticles can be made by the methods described by Zhu at al, “Double-carbon protected silicon anode for high performance lithium-ion batteries” Journal of Alloys and Compounds, Volume 812, 5 Jan. 2020, 151848, all of which are incorporated fully by reference.

The Cathode

A cathode (or positive electrode) is the electrode of the cell into which electrons flow, and from which positive charge departs. In a preferred embodiment, the cathode is made from a lithium compound such as a lithium metal oxide. In some embodiments the cathode may comprise Lithium Iron Phosphate (LFP) such as a LiFePO4-based paper composition which in some embodiments does, and in others does not include a carbon nanostructures. It may be a layered insertion cathode.

In another embodiment the cathode is made from, for example, a mixture of Li2O, Li2O2, and LiO2, or in a related embodiment, of LiNiCoMnO2 (Lithium Nickel Manganese Cobalt Oxide).

In other preferred embodiments, the cathode comprises high energy density Li-free materials such as S, FeF3, CuF2, FeS2, and MnO2, with energy densities of 1,000-1,600 Wh kg−1 and 1,500-2,200 Wh L−1 per cell.

The cathode may also include or be made entirely out of carbon nanostructures such as carbon nanotubes. These nanotubes may be structured in layers or may be arranged amorphously. The large surface area of the nanotubes increases charge capacity, while simultaneously letting charges migrate easily, increasing power.

Other cathode materials include, but are not limited to: Lithium Cobalt Oxide (or Lithium Cobaltate), Lithium Manganese Oxide (also known as spinel or Lithium Manganate), Lithium Iron Phosphate, as well as Lithium Nickel Manganese Cobalt, Lithium Nickel Cobalt Aluminum Oxide (or NCA). Li-cobalt, Li-manganese, Li-phosphate, NMC (NMC, NCM, CMN, CNM, MNC and MCN are basically the same. The stoichiometry is usually Li[Ni(1/3)Co(1/3)Mn(1/3)]O2. The order of Ni, Mn and Co is not important), various olivine structure materials, layered rock salt structure materials, and spinel structure materials.

The Electrolyte

The electrolyte may be a liquid, or preferably a solid electrolyte. Liquid electrolytes in the lithium-ion battery of the invention consist of lithium salts, such as LiPF6, LiBF4 or LiClO4 in an organic solvent, such as ethylene carbonate, dimethyl carbonate, and diethyl carbonate. A liquid electrolyte acts as a conductive pathway for the movement of cations passing from the negative to the positive electrodes during discharge. The combination of linear and cyclic carbonates (e.g., ethylene carbonate (EC) and dimethyl carbonate (DMC)) offers high conductivity and solid electrolyte interphase (SEI)-forming ability. Composite electrolytes based on POE (poly(oxyethylene)) provide a relatively stable interface.[112][113] It can be either solid (high molecular weight) and be applied in dry Li-polymer cells, or liquid (low molecular weight) and be applied in regular Li-ion cells. Room-temperature ionic liquids (RTILs) are another approach to limiting the flammability and volatility of organic electrolytes.

Solid electrolytes include ceramics such as lithium metal oxides. Solid ceramic electrolytes include ceramic and glassy types. Ceramic solid electrolytes are crystalline and include lithium super ion conductors (LISICON) and Perovskites. Glassy solid electrolytes are amorphous and are made up of similar elements to ceramic solid electrolytes. Both glassy and ceramic electrolytes can be made more ionically conductive by substituting sulfur for oxygen. In certain preferred embodiments, the electrolyte may be a dry electrolyte paste comprising graphite (or another form of carbon) and silicon and a lignin compound such as a fibrous compound from a plant or alga.

The Separator

The battery of the invention includes a separator. The separator is a permeable membrane placed between the anode and cathode. The main function of a separator is to keep the two electrodes electrically separated to prevent electrical short circuits while also allowing the transport of ionic charge carriers that are needed to close the circuit during the passage of current in an electrochemical cell, whereby the current can only pass from the anode to the cathode through a path external to the battery.

The electrons travel external to the battery through a circuit and ions travel internally, across the separator, which does not conduct electrons, and acts as an isolator.

In a preferred embodiment the separator is made of natural cellulose fibers made from algae. The algae are washed and dewatered, and may be bleached, before being rolled into sheets. The separator may comprise a plurality of sheets laid randomly or at cross-grain orientation to one another. In one embodiment, the cellulose separator may be prepared in a fashion akin to making paper, by filtration and dewatering of natural cellulose fibers (Gala, H. B., and Chiang, S. H. Filtration and dewatering: review of literature, 1980. Web. doi:10.2172/6995919). The separator exhibits very high porosity and wettability, as well as low cost and excellent ionic transport characteristics but does not conduct electrons, and acts as an isolator.

In a further preferred embodiment, the separator is made from algae, such as seaweed. More specifically the algae may be one or more of Brown Algae (Phaeophyta), Green Algae (Chlorophyta), and/or Red Algae (Rhodophyta). Other algal types may be used, including unicellular microalgae such as chlorella and the diatoms. The structure, abundance and low cost of the algae provide an advantageous natural material for making separator material with highly desirable properties.

### Components of the Invention

The invention encompasses a Nano-Alginate Battery (NAB) using silicon/carbon composite or carbon nanostructures within the anode, such as nanotubes or nanoparticles, made from Carbon, Gold or other materials, together with a high energy-density material such as silicon in contact with or blended with the carbon nanostructures, doped with boron (B) or a related element such as aluminum (Al), gallium (Ga), indium (In), thallium (Tl), and nihonium (Nh).

The anode may comprise an algal-derived material and any carbon composition, for example graphite, nano-diamonds, carbon nanotubes, diamond, or other carbon nanostructures, and/or poly(allylamine hydrochloride) etc., and in some embodiments may be a glassy carbon electrode coated with adsorbed single layers of the cationic polyelectrolyte poly(allylamine hydrochloride) (PAH). The anode may also include one or more carbon nanostructures such as carbon nanotubes, nanofibers carbon-based quantum dots, nano-diamonds, graphene and graphene oxide, and polycyclic aromatic hydrocarbons. The density of the nanostructures may be about 1.8 g/cm³. In various embodiments, the density may be from 0.5-10, or 1-7, or 1.2-5, or 1.4-3, or 1.7-2 g/cm³. In other embodiments, the density of the nanostructures may be at least 1, or at least 1.5, or at least 2, or at least 5, or at least 7 g/cm³.

In some embodiments, the invention employs a silicon-composite anode using lithium ions as charge carriers. The anode may also contain alginate materials to prevent degradation. Use of silicon-Li composites for the anode can provide a very high cycling stability. The cathode may also be a layered insertion cathode and may comprise a mixture of graphite and silicon and may include nano-carbon materials. By using a nano-carbon material as part of the cathode, no thermal runaway takes place within the electrolyte in the Nano-Alginate Battery. This results in an inherently safe battery that does not catch fire and explode whilst providing long operational life due to the presence of an organic compound which consist of thin fibers found in algae. Carbon nanomaterials may be selected from, for example: hollow nanospheres, ellipsoids (‘Fullerenes’), or carbon nanotubes, nanofibers carbon-based quantum dots, nano-diamonds, graphene and graphene oxide, and polycyclic aromatic hydrocarbons.

The cathode may be made from the same materials at the anode and typically includes graphite and silicon and may be made from Lithium Iron Phosphate (LFP) such as a LiFePO4, which in some embodiments may include a carbon nanostructures. The cathode may be made from a mixture of Li2O, Li2O2, and LiO2, or in a related embodiment, of LiNiCoMnO2 (Lithium Nickel Manganese Cobalt Oxide).

A binder material may be included that suspends the silicon or graphite particles that actively interact with the electrolyte that provides battery power. Lithium-ion batteries work by transferring lithium ions between a cathode and an anode through a liquid electrolyte. The more efficiently the lithium ions can enter the two electrodes during charge and discharge cycles, the larger the battery's capacity will be.

The separator may comprise a combination of natural fibers (lignin, wood-derived material, algal-derived material such as alginates or any other organic fibrous material etc.). It may not contain electrically conducting materials such as carbon. The porous separator material may be made from algae such as Brown Algae (Phaeophyta), Green Algae (Chlorophyta), and/or Red Algae (Rhodophyta), unicellular microalgae and diatoms. The separator may alternatively be derived from mangrove tree wood which has a high thermal value typically used in coal production. Other types of wood may be used such as American beech, Apple, Ironwood, Red oak, Shagbark Hickory, Sugar, Maple, White ash, White oak and Yellow birch. Algal-derived material such as alginate can be derived from any common algae including cyanobacteria. The algae used may be heated in a noble gas (e.g., Argon) or Nitrogen environment at temperatures of up to 1000 Celsius to convert the cyanobacteria into a material known as “hard carbon,” that can be used as a high-capacity alternative to the standard graphite-form carbon used in most batteries. This can boost energy storage and output. Algal-derived material can be used as a binder material for lithium-ion battery electrodes that can boost energy storage and eliminate the use of toxic compounds now used in manufacturing.

Alginate can be extracted from the seaweed through a simple soda-based (Na2CO3) process that generates a uniform material. Anodes may then be produced by using water-based slurry to suspend the silicon or graphite nanoparticles. Use of the alginate anodes reduces decomposition. Because the volume of silicon nanoparticles changes during operation of the battery, cracks can form and allow additional electrolyte decomposition until the pores that allow ion flow become clogged, causing battery failure. Alginate not only binds silicon nanoparticles to each other and to the collector of the anode, but they also coat the silicon nanoparticles themselves and provide a strong support for the interface, preventing degradation. Alginate can produce battery anodes with much higher capacity than graphite electrodes. An alginate composite anode may have a coulombic efficiency approaching 100%.

The electrolyte may be a dry electrolyte paste comprising graphite (or another form of carbon) and silicon and a lignin compound such as a fibrous compound from a plant or alga. The electrolyte may be a paste made from carbon and silicon and a lignin compound, forming a charge-conducting matrix in contact with the anode, the separator, and the cathode.

The present invention may be used in combination with other known designs including nickel-cadmium (NiCd), nickel-metal hydride (NiMH), lithium-ion (Li-ion), and lithium-ion polymer (Li-ion polymer) batteries. In some embodiments, at least one electrode comprises nickel oxide hydroxide and/or metallic cadmium. In other embodiments, at least one electrode comprises a nickel-metal hydride; or a compound selected from the group consisting of lithium cobalt oxide, lithium iron phosphate, lithium ion manganese oxide, lithium nickel cobalt aluminum oxide and lithium titanate (for titanate lithium-ion cells (LTO), the lithium-oxide electrode is the negative electrode). In other embodiments, at least one electrode comprises a lithium-ion polymer.

The Nano-carbon battery of the invention provides a number of advantages including having a high energy density, high cycling capacity, reduced weight compared to prior art batteries; reduced thermal runaway, and improved safety characteristics. It is also environmentally friendly and non-toxic, safe for recycling, has a lower weight and volume than traditional batteries, does not explode when punctured or crushed, is submersible in water, has no memory effect, is fact charging, has a long life cycle and has a non-magnetic body, so can be used in systems vulnerable to magnets.

### FURTHER EMBODIMENTS AND EXAMPLES

The battery of the invention may range in size and energy capacity from 3 Wh to thousands of Wh (such as in the 5040 Wh example found below). Any of the below may include an anode is doped with boron (B) or a related element such as aluminum (Al), gallium (Ga), indium (In), thallium (Tl), and nihonium (Nh).

### Embodiment 1

ANODE: comprising hollow gold nanospheres and silicon.

CATHODE: comprising Lithium Cobalt Oxide (or Lithium Cobaltate), Lithium Manganese Oxide (also known as spinel or Lithium Manganate), Lithium Iron Phosphate, as well as Lithium Nickel Manganese Cobalt, Lithium Nickel Cobalt or Aluminum Oxide or NCA, and carbon nanostructures.

SEPARATOR: comprising natural cellulose fibers made from algal material.

### Embodiment 2

ANODE: comprising carbon nanospheres and silicon.

CATHODE: comprising Lithium Cobalt Oxide (or Lithium Cobaltate), Lithium Manganese Oxide (also known as spinel or Lithium Manganate), Lithium Iron Phosphate, as well as Lithium Nickel Manganese Cobalt, Lithium Nickel Cobalt Aluminum Oxide or NCA, and carbon nanostructures such as carbon nanotubes.

ELECTROLYTE: comprising any suitable a liquid or a solid electrolyte.

SEPARATOR: comprising natural cellulose fibers made from algal material.

### Embodiment 3

ANODE: comprising carbon or gold nanospheres and silicon mixed with an alginate

CATHODE: comprising lithium iron phosphate (LiFePO4) and carbon nanostructures such as carbon nanotubes.

ELECTROLYTE: comprising any suitable a liquid or a solid electrolyte.

SEPARATOR: comprising natural cellulose fibers made from algal material.

### Embodiment 4

ANODE: comprising a silicon/carbon composite

CATHODE: substantially comprised only of carbon nanostructures.

ELECTROLYTE: comprising any suitable a liquid or a solid electrolyte.

SEPARATOR: comprising natural cellulose fibers made from algal material.

### Embodiment 5

ANODE: comprising carbon nanotubes

CATHODE: comprising carbon nanotubes.

ELECTROLYTE: comprising an electrically conducting liquid, paste or gel or solid often comprising a lignin compound, as well as silicon and a carbon compound and a dissociated salt.

SEPARATOR: comprising fibrous natural material derived from algae.

### Embodiment 6

ANODE: comprising a silicone-Li anode comprising finely-milled silicone or a nanometer particle size, with lithium ions as charge carriers.

CATHODE: comprising a layered insertion cathode and comprising a carbon and silicon mixture.

ELECTROLYTE: comprising an electrically conducting liquid, paste or gel or solid often comprising a lignin compound, as well as silicon and a carbon compound and a dissociated salt.

SEPARATOR: comprising fibrous natural material derived from algae.

An Example of Battery Characteristics for a 5040 Wh Battery

A 5040 Wh example of the battery of the invention has the following characteristics.

| | | |
|---|---|---|
| Mechanical | Cell | Lithium-ion + alginate binder |
| | Dimension(D*W*H) | 451 × 350 × 250 mm (with |
| | | battery case) |
| | Total weight of battery | About 45 KG (with |
| | | battery case) |
| Electrical | Rated Capacity | 100 Ah |
| Characteristics | Min Capacity | 100 Ah |
| | High Rate Discharge | >90% Rated Capacity |
| | Capacity | |
| | Discharge Capacity @ | >70% Rated Capacity |
| | −20° C.(−4° F.) | |
| | Nominal Operating | 50.4 V |
| | Voltage | |
| | Minimum Operating | 42 V |
| | Voltage | |
| | Maximum Operating | 58.8 V |
| | Voltage | |
| | Nominal Energy | 5040 Wh |
| | Internal Impedance(@ | ≤20 mΩ |
| | 1000 Hz.) | |
| | Cycle Life | >2000 Cycles @ 1 C 100% |
| | | DOD |
| | Months Self Discharge | ≤5% @ 25° C.(77° F.) |
| | Efficiency of Charge | 100% @ ⅓ C |
| | Efficiency of Discharge | 95% @1 C |
| Standard | Max Charge Voltage | 59 V to 60 V |
| Charge | Charge Current | ½ C, 50 A |
| | Max Charge Current | 1 C, 100 A |
| BMS | Over charge detection | 4.25 V ± 0.025 V |
| Overcharge | voltage | |
| protection | Over charge detection | 0.7 S-1.3 S |
| (Each cell) | delay time | |
| | Over charge release | 4.10 ± 0.05 V |
| | voltage | |
| Standard | Standard discharge | 0.5 C 50 A |
| Discharge | Current | |
| | Max continous | 1 C, 100 A |
| | Discharge Current | |
| | Spontaneous | 3 C, 300 A @ 5 seconds |
| | Discharge Current | duration only |
| BMS Over- | Over discharge | 2.80 V ± 0.07 V |
| discharge | detection voltage | |
| protection | Over discharge | 1.6 ± 0.5 S |
| (Each cell) | detection delay time | |
| | Over discharge release | 3.00 ± 0.75 V |
| | voltage | |
| BMS Over | Over current detection | 800 ± 50 A |
| current | current | |
| protection | Detection delay time | 1.6 ± 0.5 S |
| | Release condition | Cut load, automatically recover |
| BMS Short | Detection condition | Exterior shot circuit |
| circuit | Detection delay time | 230 uS-500 uS |
| protection | Release condition | Cut load, automatically recover |
| Environmental | Charge Temperature | 0° C. to 45° C. |
| | | (32° F. to 113° F.) @ |
| | | 65 ± 20% Relative Humidity |
| | Discharge Temperature | −20° C. to 60° C. |
| | | (−4° F. to 140° F.) @ |
| | | 65 ± 20% Relative Humidity |
| | Storage Temperature | ≤1 Month, −20° C. to |
| | | 60° C.(−4° F. to 140° F.) |
| | | @ 65 ± 20% Relative |
| | | Humidity |
| | | ≤6 Month, −20° C. to 30° C. |
| | | (−4° F. to 80° F.) @ |
| | | 65 ± 20% |
| | | Relative Humidity |

### Definitions and Further Information Relevant to Embodiments

This specification incorporates by reference all documents referred to, including but not limited to such documents which are open to public inspection with this specification. All numerical quantities mentioned herein include quantities that may be plus or minus 20% of the stated amount in every case, including where percentages are mentioned. As used in this specification, the singular forms “a, an”, and “the” include plural reference unless the context clearly dictates otherwise. Thus, for example, a reference to “a part” includes a plurality of such parts, and so forth. The term “comprises” and grammatical equivalents thereof are used in this specification to mean that, in addition to the features specifically identified, other features are optionally present. For example, a composition “comprising” (or “which comprises”) ingredients A, B and C can contain only ingredients A, B and C, or can contain not only ingredients A, B and C but also one or more other ingredients. The term “consisting essentially of” and grammatical equivalents thereof is used herein to mean that, in addition to the features specifically identified, other features may be present which do not materially alter the claimed invention. The term “at least” followed by a number is used herein to denote the start of a range beginning with that number (which may be a range having an upper limit or no upper limit, depending on the variable being defined). For example, “at least 1” means 1 or more than 1, and “at least 80%” means 80% or more than 80%. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Where reference is made in this specification to a method comprising two or more defined steps, the defined steps can be carried out in any order or simultaneously (except where the context excludes that possibility), and the method can optionally include one or more other steps which are carried out before any of the defined steps, between two of the defined steps, or after all the defined steps (except where the context excludes that possibility). When, in this specification, a range is given as “(a first number) to (a second number)” or “(a first number)-(a second number)”, this means a range whose lower limit is the first number and whose upper limit is the second number. For example, “from 40 to 70 microns” or “40-70 microns ” means a range whose lower limit is 40 microns, and whose upper limit is 70 microns.

1. A battery wherein the anode material comprises nanostructures of carbon and/or metal, and also comprises silicon particles; and
wherein the cathode comprises a lithium compound; and
wherein the electrolyte is a solid or liquid electrolyte, and
wherein the separator comprises an organically-derived material acting as an electrical isolator.

2. The battery of claim 1 wherein the anode further comprises an algal-derived material blended with said nanostructures and said silicon particles.

3. The battery of claim 2 wherein the anode further comprises a blend of said nanostructures together with graphite particles and silicon particles and an algal-derived material.

4. The battery of claim 3 wherein the algal-derived material is an alginate.

5. The battery of claim 3 wherein the anode comprises silicon microparticles encapsulated in a graphene shell.

6. The battery of claim 3 wherein the anode and cathode nanostructures are nanotubes of gold or of carbon.

7. The battery of claim 3 wherein the anode and cathode nanostructures are nanospheres of gold or of carbon.

8. The battery of claim 3 wherein the anode comprises a silicone-Li anode comprising finely-milled silicone or a nanometer particle size, with lithium ions as charge carriers.

8. The battery of claim 3 wherein the electrolyte is a solid electrolyte comprising a blend of alginate, silicon particles, carbon or graphite particles and a dissociated salt.

9. The battery of claim 8 wherein the electrolyte is a solid electrolyte is a ceramic.

10. The battery of claim 9 wherein the solid electrolyte is a lithium metal oxide ceramic.

11. The battery of claim 9 wherein the solid electrolyte is a lithium super-ion conductor.

12. The battery of claim 3 wherein the cathode comprises nanostructures of carbon and/or a metal compound, and an material selected from the group consisting of a lithium oxide, a lithium cobalt oxide, a lithium manganese oxide, a lithium iron phosphate, a lithium nickel manganese cobalt, a lithium nickel cobalt and aluminum oxide.

13. The battery of claim 12 wherein the cathode additionally comprises a material made from algae.

14. The battery of claim 3 wherein the cathode is substantially comprised only of carbon nanostructures.

15. The battery of claim 3 wherein the cathode is a layered insertion cathode and comprising a carbon and silicon mixture.

16. The battery of claim 3 wherein the anode, the cathode, the electrolyte and the separator all comprise an alginate material.

17. A battery wherein the anode comprises a blend of graphite, carbon or metal nanostructures, silicon particles and an algal-derived material; and wherein the cathode comprises a lithium metal oxide and an algal-derived material; and wherein the electrolyte is a ceramic lithium metal oxide; and wherein the separator comprises an algal-derived material.

18. The battery of claim 17 wherein the anode is a silicone-Li anode comprising finely-milled silicone or a nanometer particle size; and the cathode is a layered insertion cathode and comprising a carbon and silicon mixture.
